(19) United States
(12) Patent Application Publication
(10) Pub. No.: US 2024/0389201 A1
(43) Pub. Date: Nov. 21, 2024

(54) FILM HEATER AND HEATER-EQUIPPED GLASS

(71) Applicant: TDK CORPORATION, Tokyo (JP)

(72) Inventors: Shouhei HARADA, Tokyo (JP); Koji MISHIMA, Tokyo (JP); Yoshinori SATO, Tokyo (JP); Kazushi YAMADA, Tokyo (JP); Hideaki ITOU, Tokyo (JP)

(73) Assignee: TDK CORPORATION, Tokyo (JP)

(21) Appl. No.: 18/288,243

(22) PCT Filed: Apr. 25, 2022
(86) PCT No.: PCT/JP2022/018734

§ 371 Date: Oct. 25, 2023

(30) Foreign Application Priority Data
Apr. 26, 2021 (JP) 2021-074139

(51) Int. Cl. H05B 3/84; B60S 1/02; E06B 7/12

(52) U.S. Cl. CPC H05B 3/84; B60S 1/026; E06B 7/12

(57) ABSTRACT

A film heater includes a transparent substrate and a transparent heating element, wherein a surface of the transparent substrate opposite to the transparent heating element has a water contact angle of 55° or less or 90° or more. A heater-equipped glass includes the film heater, a glass plate opposite to the surface, and an electrode in contact with the transparent heating element of the film heater, the electrode being disposed between the film heater and the glass plate.

### TECHNICAL FIELD

The present disclosure relates to film heater and heater-equipped glass.

### BACKGROUND ART

Glass with a heater function is used for glass of vehicles, outdoor display devices, buildings, and the like for preventing fogging, melting snow, preventing dew condensation, and the like. As such glass with a heater function, glass with a heater function in which a nichrome thin wire is disposed in glass is conventionally known. However, in the case of such glass with a heater function, the nichrome thin wire inhibits the transmission visibility. Therefore, it has been studied to use a transparent conductive film for the heater. For example, Patent Document 1 proposes a transparent film heater having a transparent conductive layer containing a conductive polymer and a current-carrying electrode on at least one surface of a transparent substrate.

### CITATION LIST

Patent Literature

[Patent Document 1] Japanese Unexamined Patent Publication No. 2016-126913

### SUMMARY OF INVENTION

### Technical Problem

When condensation occurs on a surface of a transparent body such as glass, fogging occurs due to water droplets, and visibility is impaired. Accordingly, the present disclosure provides a film heater capable of rapidly reducing water droplets. The present disclosure provides a heater-equipped glass having excellent visibility by including such a film heater.

### Solution to Problem

The present disclosure provides a film substrate including: a transparent substrate; and a transparent heating element, in which a surface of the transparent substrate opposite to the transparent heating element has a water contact angle of 55° or less or 90° or more.

The film heater has a surface having a water contact angle of 55° or less or 90° or more. Even if dew condensation occurs on such a surface and water droplets stick thereto, the water droplets can be rapidly reduced by heating the surface with the transparent heating element. The reason for this is as follows. That is, when the water contact angle of the surface is 55° or less, the contact surface between the water droplet and the surface (exposed surface) of the film heater may be sufficiently large. Thus, heat from the transparent heat generating layer can be efficiently transmitted to the water droplet. Accordingly, water droplets sticking to the surface can be rapidly reduced. On the other hand, when the water contact angle of the surface is 90° or more, condensation is less likely to occur and the amount of sticking water droplets can be reduced. Therefore, water droplets sticking to the surface can be rapidly reduced by heat from the transparent heat generating layer.

The film heater may further include, on a side of the transparent substrate opposite to a transparent heating element, a first hard coat layer containing a first resin component, and the first hard coat layer may have the surface. Thus, the water contact angle can be flexibly adjusted.

The transparent heating element may be layered, and may include a first dielectric layer, a metal layer including one or both of silver and silver alloy, and a second dielectric layer in the order presented along a stacking direction of the transparent substrate and the transparent heating element. Such a transparent heating element can generate heat over the entire surface. Accordingly, the surface of the film heater is uniformly heated, and water droplets can be reduced more quickly. In addition, it is possible to prevent fogging from remaining due to unevenness in the distribution of water droplets and to sufficiently increase visibility.

The film heater may include a second hard coat layer containing a second resin component and a filler between the transparent substrate and the transparent heating element. This makes it possible to sufficiently increase the adhesion between the transparent substrate and the transparent heating element. Such a film heater has excellent durability.

The present disclosure provides a heater-equipped glass including any one of the film heaters described above, a glass plate opposite to the surface, and an electrode in contact with the transparent heating element of the film heater, the electrode being disposed between the film heater and the glass plate.

The heater-equipped glass comprises any one of the film heaters described above. Therefore, water droplets sticking to the surface can be rapidly reduced. Accordingly, it can be suitably used for applications requiring high visibility. For example, it is suitably used for vehicles, outdoor display devices, and buildings. However, the applications of the heater and the heater-equipped glass are not limited to those described above.

### Advantageous Effects of Invention

It is possible to provide a film heater capable of quickly reducing water droplets can be provided. In addition, by providing such a film heater, it is possible to provide a heater-equipped glass having excellent visibility.

### BRIEF DESCRIPTION OF DRAWINGS

FIG. 1 is a schematic cross-sectional view illustrating an example of a film heater.

FIG. 2 is a schematic cross-sectional view illustrating an example of a heater-equipped glass.

FIG. 3 is a schematic diagram for explaining an evaluation method of Examples.

FIG. 4(A) is an optical microscope photograph showing water droplets sticking to a surface of the film heater (exposure time: 0.5 minutes) of Example 1. FIG. 4(B) is an optical microscope photograph showing water droplets attached to the surface of the film heater (exposure time: 3 minutes) of Example 1.

FIG. 5(A) is an optical microscope photograph showing water droplets sticking to a surface of the film heater (exposure time: 0.5 minutes) of Example 2. FIG. 5(B) is an optical microscope photograph showing water droplets attached to the surface of the film heater (exposure time: 3 minutes) of Example 2.

FIG. 6(A) is an optical microscope photograph showing water droplets sticking to a surface of the film heater (exposure time: 0.5 minutes) of Example 3. FIG. 6(B) is an optical microscope photograph showing water droplets attached to the surface of the film heater (exposure time: 3 minutes) of Example 3.

FIG. 7(A) is an optical microscope photograph showing water droplets sticking to a surface of the film heater (exposure time: 0.5 minutes) of Comparative Example 1. FIG. 7(B) is an optical microscope photograph showing water droplets attached to the surface of the film heater (exposure time: 3 minutes) of Comparative Example 1.

FIG. 8 is a graph showing the relationship between the contact angle of water and the time required to remove water droplets (removal time).

### DESCRIPTION OF EMBODIMENTS

Hereinafter, embodiments of the present disclosure will be described with reference to the accompanying drawings. However, the following examples are illustrative for describing the present disclosure and are not intended to limit the present disclosure to the following contents. In the following description, elements having the same structure or the same function are denoted by the same reference numerals, and redundant description thereof will be omitted. Positional relationships such as up, down, left, and right are based on positional relationships illustrated in the drawings unless otherwise specified. The dimensional ratio of each element is not limited to the illustrated ratio.

The film heater according to one embodiment includes at least a transparent substrate and a transparent heating element. The film heater may include a stacked body in which a layered transparent substrate (transparent substrate layer) and a layered transparent heating element (transparent heat generating layer) are at least stacked. The stacked body may be a stacked body of a transparent substrate layer and a transparent heat-generating layer, or a stacked body of a transparent substrate layer, a transparent heat-generating layer, and one or more optional layers different from these layers. The optional layer may be stacked on the transparent substrate layer and/or the transparent heat generating layer, or may be stacked between the transparent substrate layer and the transparent heat generating layer. A water contact angle of a surface (exposed surface) of the film heater on a side opposite to the transparent heating element side of the transparent substrate is 55° or less or 90° or more. This surface (exposed surface) may be a surface opposite to the transparent heating element side of the transparent substrate orthogonal to the stacking direction of the stacked body.

When the water contact angle of the surface is 55° or less, since the surface is sufficiently hydrophilic, the contact area between a water droplet and the surface can be sufficiently increased. Thus, heat from the transparent heating element can be efficiently transferred to the water droplet. Accordingly, it is possible to rapidly reduce water droplets sticking to the surface and fogging caused by the water droplets. In addition, in a case where a solid content is included in the water droplet, it is possible to prevent aggregation of the solid content such as dust and sand remaining after removing the water droplet. Accordingly, high visibility can be sufficiently maintained. The water contact angle of the surface may be 50° or less, or may be 45° or less, from the viewpoint of more rapidly reducing water droplets and from the viewpoint of preventing aggregation of solid content. The lower limit of the water contact angle of the surface is not limited, and may be more than 0°, or may be 10° or more.

In a case where the water contact angle of the surface is 90° or more, since the surface has sufficiently high water repellency, dew condensation hardly occurs, and it is possible to reduce the sticking amount of water droplets and fogging. In addition, since the sticking amount of water droplets is small, it is possible to rapidly reduce water droplets and fogging caused thereby by heat from the transparent heating element. From the viewpoint of further reducing the sticking amount of water droplets, the water contact angle of the surface may be 100° or more, or may be 105° or more. The upper limit of the water contact angle of the surface is not limited, and may be 110° or less. The water contact angle of the surface may be adjusted, for example, by UV irradiation of the surface of the transparent substrate.

In the present disclosure, “transparent” means that visible light is transmitted, and light may be scattered to some extent. The concept of “transparent” in the present disclosure also includes products that scatter light and are generally referred to as translucent. The transmissivity of visible light in the stacking direction of the film heater (transparent film heater) having the stacked structure may be, for example, 75% or more, and may be 80% or more. Visible light in the present disclosure refers to light in a range of wavelengths from 360 to 740 nm.

The transparent substrate (transparent substrate layer) included in the stacked body may be formed of, for example, a flexible organic resin film. The organic resin film may be an organic resin sheet. Examples of the organic resin film include polyester films such as polyethylene terephthalate (PET) films and polyethylene naphthalate (PEN) films; polyolefin films such as polyethylene films and polypropylene films; polycarbonate films; acrylic films; norbornene films; polyarylate films; polyether sulfone films; diacetylcellulose films; and triacetyl cellulose films. Among these, polyester films such as polyethylene terephthalate (PET) films and polyethylene naphthalate (PEN) films are preferable. One of those mentioned above may be used singly or two or more of them may be used in combination. However, the transparent substrate is not limited to one made of organic resins, and may be a molded product of inorganic compounds such as soda-lime glass, alkali-free glass, and quartz glass.

The transparent substrate in the film heater is preferably thick from the viewpoint of rigidity. On the other hand, the transparent substrate is preferably thin from the viewpoint of making the film heater thin. From this point of view, the transparent substrate is, for example, 10 to 200 μm thick.

As the transparent heating element, one that is transparent and capable of generating heat can be appropriately used. The transparent heating element may have a stacked structure. Such a transparent heating element may be a layered material (transparent heating layer) including a first dielectric layer, a metal layer containing one or both of silver and silver alloy, and a second dielectric layer in this order. Such a transparent heating element has excellent transparency and can generate heat on the entire surface. Accordingly, the surface of the film heater is uniformly heated, and water droplets can be reduced more quickly. In addition, it is possible to prevent unevenness of distribution of water droplets and remaining of fogging due to the unevenness, and to sufficiently increase visibility. Further, although the linear transparent heating element may be burned out depending on the state of use, such a phenomenon can be avoided because the transparent heating layer is heated on the entire surface. However, a linear transparent heating element may be used. The transparent heating element may be, for example, silver nanowires or may be a metal mesh.

The film heater may include a first hard coat layer containing a first resin component on a side of the transparent substrate opposite the transparent heating element side. The first hard coat layer is an outermost layer, and a surface (exposed surface) of the first hard coat layer may have the above-described water contact angle. Accordingly, the water contact angle can be flexibly adjusted.

The first hard coat layer contains, for example, a resin component obtained by curing a resin composition (first resin component). It is preferable that the resin composition contains at least one selected from a thermosetting resin composition, an ultraviolet curable resin composition, and an electron beam curable resin composition. As a thermosetting resin composition, at least one selected from epoxy resins, phenoxy resins, and melamine resins may be contained. The resin composition may also contain a hydrophilic component or a hydrophobic component for adjusting the water contact angle of the surface.

The resin composition may contain, for example, a curable compound having an energy ray-reactive group such as a (meth)acryloyl group or a vinyl group. The expression “(meth)acryloyl group” is intended to include at least one of an acryloyl group and a methacryloyl group. It is preferable that the curable compound contains a polyfunctional monomer or oligomer having two or more, preferably three or more energy ray-reactive groups in one molecule.

The curable compound preferably contains an acrylic monomer. Specific examples of the acrylic monomer include 1,6-hexanediol di(meth)acrylate, triethylene glycol di(meth)acrylate, ethylene oxide-modified bisphenol A di(meth)acrylate, trimethylolpropane tri(meth)acrylate, trimethylolpropane ethylene oxide-modified tri(meth)acrylate, trimethylolpropane propylene oxide-modified tri(meth)acrylate, pentaerythritol tetra(meth)acrylate, ditrimethylolpropane tetra(meth)acrylate, dipentaerythritol penta(meth)acrylate, dipentaerythritol hexa(meth)acrylate, pentaerythritol tri(meth)acrylate, and 3-(meth)acryloyloxyglycerin mono(meth)acrylate. However, the acrylic monomer is not necessarily limited thereto. Examples thereof also include urethane-modified acrylates and epoxy-modified acrylates.

As the curable compound, a compound having a vinyl group may be used. Examples of the compound having a vinyl group include ethylene glycol divinyl ether, pentaerythritol divinyl ether, 1,6-hexanediol divinyl ether, trimethylolpropane divinyl ether, ethylene oxide-modified hydroquinone divinyl ether, ethylene oxide-modified bisphenol A divinyl ether, pentaerythritol trivinyl ether, dipentaerythritol hexavinyl ether, and ditrimethylolpropane polyvinyl ether. However, the compound having a vinyl group is not necessarily limited thereto.

When the curable compound is cured by ultraviolet rays, the resin composition contains a photopolymerization initiator. As the photopolymerization initiator, various photopolymerization initiators can be used. For example, a photopolymerization initiator may be appropriately selected from known compounds including acetophenone-based, benzoin-based, benzophenone-based, and thioxanthone-based compounds. More specific examples thereof include Darocure 1173, Irgacure 651, Irgacure 184, Irgacure 907, and Irgacure 127 (product names, manufactured by Ciba Specialty Chemicals), and KAYACURE DETX-S (product name, manufactured by Nippon Kayaku Co., Ltd.).

The content of the photopolymerization initiator may be 0.01 to 20% by mass, or 1 to 10% by mass based on the mass of the resin composition. The resin composition may be a known resin composition containing an acrylic monomer and a photopolymerization initiator. Examples of the polymer composition containing an acrylic monomer and a photopolymerization initiator include SD-318 (product name, manufactured by Dainippon Ink and Chemicals, Inc.), which is ultraviolet curable, and XNR5535 (product name, manufactured by Nagase & Co., Ltd.).

When a resin composition curable by energy rays is used, the resin composition can be cured by irradiation with energy rays such as ultraviolet rays.

Examples of hydrophilic components contained in the polymer composition include AICAAITRON Z-948-2L (product name) manufactured by Aica Kogyo Company, Limited and Lioduras LAF2700 (product name) manufactured by Toyo Ink Co., Ltd. The content of the hydrophilic component in the entire curable compound may be 30 to 100% by mass, or may be 37 to 100% by mass. By changing this content, the water contact angle of the surface of the film heater can be adjusted.

Examples of the hydrophobic components include PHOLUCID 540C (product name) manufactured by CHUGOKU MARINE PAINTS, LTD. and Lioduras LCH6000 (product name) manufactured by Toyo Ink Co., Ltd. The content of the hydrophobic component in the entire curable compound may be 70 to 100% by mass, or may be 80 to 100% by mass. By changing this content, the water contact angle of the surface of the film heater can be adjusted.

The first hard coat layer can be formed by applying a coating material (dispersion liquid) containing a solvent and a resin composition onto one surface of a substrate, drying the coating material, and curing the resin composition. The coating can be carried out by a known method. Examples of the coating method include an extrusion nozzle method, a blade method, a knife method, a bar coat method, a kiss coat method, a kiss reverse method, a gravure roll method, a dip method, a reverse roll method, a direct roll method, a curtain method, and a squeezing method. As the solvent, an ordinary organic solvent can be used.

The thickness of the first hard coat layer may be, for example, 0.1 to 10 μm, or may be 0.5 to 5 μm. Accordingly, adhesion between the first hard coat layer and a layer in direct contact with the first hard coat layer (for example, transparent substrate) can be sufficiently increased, and occurrence of unevenness in thicknesses, wrinkles, and the like can be sufficiently suppressed. The refractive index of the first hard coat layer may be, for example, 1.40 to 1.60. The absolute difference between the refractive indices of the transparent substrate and the first hard coat layer may be, for example, 0.1 or less.

The film heater may include a second hard coat layer containing a second resin component and a filler between the transparent substrate and the transparent heating element. This makes it possible to sufficiently increase the adhesion between the transparent substrate and the transparent heating element. Such a film heater has excellent durability.

The second hard coat layer may contain components similar to those of the first hard coat layer. For example, the resin composition may contain a resin component obtained by curing a resin composition (second resin component) and a filler dispersed in the second resin component. Examples of the second resin component include the same components as the first resin component. The filler contained in the second hard coat layer may be, for example, a silica filler.

The second hard coat layer can be formed by applying a coating material (dispersion liquid) containing a solvent, a polymer composition, and a filler to one surface of the transparent substrate, drying the coating material, and curing the polymer composition. The coating can be carried out in the same manner as in the formation of the first hard coat layer. The second resin component in the second hard coat layer may be the same as or different from the first resin component in the first hard coat layer.

From the viewpoint of improving adhesion between the second hard coat layer and a layer adjacent thereto, the average grain size of the filler dispersed in the resin components in the second hard coat layer may be 10 nm or more, or may be 20 nm or more. From the viewpoint of ensuring sufficient transparency, the average grain size of the filler may be 200 nm or less, or may be 150 nm or less. The average grain size is a grain size (median size, D50) when an integrated value from a small grain size reaches 50% of the whole in a cumulative distribution of a grain size distribution on a number basis measured by using a grain size distribution measuring device by a laser diffraction/scattering method. The filler may be treated with a silane coupling agent, and an energy ray-reactive group such as a (meth)acryloyl group and/or a vinyl group may be formed on the surface in a film shape of the filler.

The content of the filler relative to the resin component in the second hard coat layer may be 8 to 20% by mass. From the viewpoint of sufficiently increasing the adhesion between the second hard coat layer and the layer in direct contact therewith, the lower limit of the content may be 10% by mass and may be 12% by mass. From the viewpoint of sufficiently lowering the absorptance of visible light of the film heater, the upper limit of the content may be 17% by mass or 15% by mass. When the content of the filler is too small, the influence of thermal expansion and swelling of the resin component increases in a high-temperature and high-humidity environment, and durability tends to be impaired. On the other hand, when the content of the filler is too large, the absorption rate of visible light tends to increase.

The thickness of the second hard coat layer may be, for example, 0.1 to 10 μm, or may be 0.5 to 5 μm. As a result, it is possible to sufficiently suppress the occurrence of thickness unevenness, wrinkles, and the like while sufficiently increasing the adhesion between the first hard coat layer and the layer directly contacting the first hard coat layer. The refractive index of the first hard coat layer may be, for example, 1.40 to 1.60. The absolute value of the difference in refractive index between the substrate and the second hard coat layer may be, for example, 0.1 or less.

In the film heater having such a configuration, even when water droplets are sticking to a surface and fogging occurs, the surface is heated by the transparent heating element, and thus the water droplets and fogging can be rapidly reduced. Therefore, it is useful as a heater for glass of a vehicle in which a quick defogging function is particularly required.

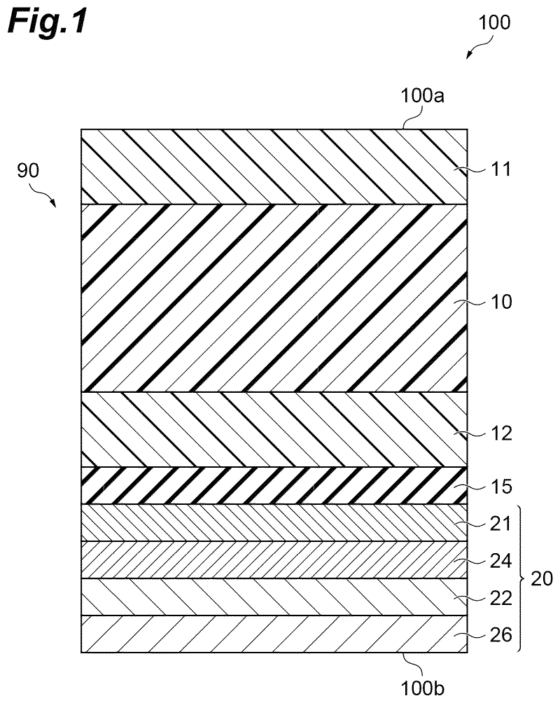

FIG. 1 is a schematic cross-sectional view illustrating an example of a film heater. A film heater 100 in FIG. 1 includes a first hard coat layer 11, a transparent substrate 10, a second hard coat layer 12, a high refractive index layer 15 and a transparent heating element 20 in this order. The transparent heating element 20 is provided with a first dielectric layer 21, a metal layer 24 containing one or both of silver and silver alloy, a second dielectric layer 22, and an ITO layer 26 in this order from the transparent substrate 10 side. That is, the transparent heating element 20 has a stacked structure in which the first dielectric layer 21, the metal layer 24 containing one or both of silver and silver alloy, the second dielectric layer 22, and the ITO layer 26 are stacked in this order. The above description applies to the transparent substrate 10, the first hard coat layer 11, and the second hard coat layer 12. “ITO” in the present disclosure is tin-doped indium oxide.

The film heater 100 has a surface 100a (exposed surface) with a water contact angle in the range described above. The surface 100a is made of the first hard coat layer 11. Water droplets and resultant fogging on the surface 100a can be removed from the surface 100a by evaporation due to heat generated by the transparent heating element 20.

The high refractive index layer 15 is a layer that has a higher index of refraction than the transparent substrate 10, the first hard coat layer 11 and the first dielectric layer 21. The high refractive index layer 15 may be a layer (third dielectric layer) having a composition different from that of the first dielectric layer 21. By providing the high refractive index layer 15, it is possible to reduce the reflectivity of visible light on the transparent substrate 10 side and improve the flexibility in selecting the material of the first dielectric layer 21. The high refractive index layer 15 may contain oxides or nitrides, for example, and may have a refraction index of 1.8 to 2.5. By providing such a high refractive index layer 15, the reflectivity of visible light on the transparent substrate 10 side can be sufficiently reduced. The high refractive index layer 15 may contain at least one selected from silicon nitride, niobium oxide, and titanium oxide from the viewpoint of improving the adhesion to the first dielectric layer 21 while sufficiently reducing the reflectivity of visible light on the transparent substrate 10 side.

Preferably, the high refractive index layer 15 contains silicon nitride. Accordingly, when the filler contained in the second hard coat layer 12 is a silica filler, the affinity between the two becomes high. Therefore, the adhesion between the second hard coat layer 12 and the high refractive index layer 15 is increased, and the durability of the film heater can be further improved.

The high refractive index layer 15 is, for example, 5 to 40 nm, preferably 10 to 30 nm, from the viewpoint of reducing both reflectivity and transmissivity in a balanced manner when visible light is incident along the stacking direction.

The high refractive index layer 15 can be formed by DC-magnetron sputtering, for example. The method of forming the film on the high refractive index layer 15 is not particularly limited, and the film may be formed by another vacuum film forming method using plasma, an ion beam, or the like. Such a high refractive index layer 15 has a smooth surface.

One or both of the first dielectric layer 21 and the second dielectric layer 22 may be, for example, a layer containing metallic oxides different from ITO, a layer containing metallic oxides (excluding ITO) as a primary component, or a layer composed of only metallic oxides (excluding ITO).

The first dielectric layer 21 may contain, for example, four components: zinc oxide, tin oxide, indium oxide, and titanium oxide or three components: zinc oxide, indium oxide, and titanium oxide as primary components. When the first dielectric layer 21 contains the above four components, the first dielectric layer 21 can have both sufficiently high conductivity and transparency can be obtained. The zinc oxide is, for example, ZnO, and the indium oxide is, for example, In₂O₃. The titanium oxide is, for example, TiO₂, and the tin oxide is, for example, SnO₂. The ratio of metallic atoms to oxygen atoms in each metallic oxide may be deviated from the stoichiometric ratio.

The “primary component” in the present disclosure means that the ratio to the whole is 80% by mass or more. The resistance of the first dielectric layer 21 may be higher resistance than that of the second dielectric layer 22. Accordingly, the content of tin oxide in the first dielectric layer 21 may be lower than that in the second dielectric layer 22, or may not contain tin oxide.

In the case where the first dielectric layer 21 contains three components: zinc oxide, indium oxide, and titanium oxide, when the three components each were converted into ZnO, In₂O₃, and TiO₂, the content of ZnO based on the total of the three components is preferably the highest of the three components. The content of ZnO with respect to the total of the three components is, for example, 45 mol % or more from the viewpoint of suppressing the absorption rate of visible light of the first dielectric layer 21. In the first dielectric layer 21, the content of ZnO based on the total of the above three components is, for example, 85 mol % or less from the viewpoint of sufficiently enhancing durability under a high-temperature and high-humidity environment.

In the first dielectric layer 21, the content of In₂O₃ with respect to the total of the three components is, for example, 35 mol % or less from the viewpoint of suppressing the absorption rate of visible light of the first dielectric layer 21. In the first dielectric layer 21, the content of In₂O₃ with respect to the total of the above three components is, for example, 10 mol % or more from the viewpoint of sufficiently increasing durability under a high-temperature and high-humidity environment.

In the first dielectric layer 21, the content of TiO₂ based on the total of the three components is, for example, 20 mol % or less from the viewpoint of reducing the absorption rate of visible light of the first dielectric layer 21. In the first dielectric layer 21, the content of TiO₂ with respect to the total of the above three components is, for example, 5 mol % or more from the viewpoint of sufficiently enhancing durability under a high-temperature and high-humidity environment. The content of each of the three components is a value determining by converting zinc oxide, indium oxide, and titanium oxide into ZnO, In₂O₃, and TiO₂, respectively.

The second dielectric layer 22 may contain, for example, four components: zinc oxide, indium oxide, titanium oxide, and tin oxide as primary components. The second dielectric layer 22 can have both electric conductivity and high transparency by containing the above four components as primary components. The zinc oxide is, for example, ZnO, and the indium oxide is, for example, In₂O₃. The titanium oxide is, for example, TiO₂, and the tin oxide is, for example, SnO₂. The ratio of the metallic atoms to the oxygen atoms in the metallic oxides may be deviated from the stoichiometric ratio.

In the second dielectric layer 22, the content of zinc oxide based on the total of the four components is, for example, 20 mol % or more from the viewpoint of sufficiently increasing the conductivity while maintaining high transparency. In the second dielectric layer 22, the content of zinc oxide based on the total of the four components is, for example, 68 mol % or less from the viewpoint of sufficiently enhancing durability under a high-temperature and high-humidity environment.

In the second dielectric layer 22, the content of indium oxide based on the total of the four components is, for example, 35 mol % or less from the viewpoint of setting the transmissivity within an appropriate range while sufficiently lowering the surface resistance. In the second dielectric layer 22, the content of indium oxide based on the total of the four components is, for example, 15 mol % or more from the viewpoint of sufficiently increasing durability under a high-temperature and high-humidity environment.

In the second dielectric layer 22, the content of titanium oxide based on the total of the four components is, for example, 20 mol % or less from the viewpoint of ensuring the transmissivity of visible light. In the second dielectric layer 22, the content of titanium oxide based on the total of the four components is, for example, 5 mol % or more from the viewpoint of sufficiently enhancing alkali resistance.

In the second dielectric layer 22, the content of tin oxide based on the total of the four components is, for example, 40 mol % or less from the viewpoint of ensuring high transparency. In the second dielectric layer 22, the content of tin oxide based on the total of the four components is, for example, 5 mol % or more from the viewpoint of sufficiently increasing durability under a high-temperature and high-humidity environment. The contents of each of the four components is a value determined by converting zinc oxides, indium oxides, titanium oxides, and tin oxides into ZnO, In₂O₃, TiO₂, and SnO₂, respectively.

The first dielectric layer 21 and the second dielectric layer 22 combine functions such as adjusting optical characteristics, protecting a metal layer, and ensuring electric conductivity. The first dielectric layer 21 and the second dielectric layer 22 may contain a trace component or an inevitable component in addition to the above-described components to the extent that the functions thereof are not significantly compromised. However, from the viewpoint of obtaining a film heater having sufficiently high characteristics, the proportion of the above three components in the first dielectric layer 21 and the total ratio of the above four components in the second dielectric layer 22 is preferably higher. Both the proportions are, for example, 95% by mass or more and preferably 97% by mass or more. The first dielectric layer 21 may be a layer consisting of the three components. The second dielectric layer 22 may be a layer consisting of the four components.

The composition of the first dielectric layer 21 may be the same as or different from the composition of the second dielectric layer 22. When the compositions of the first dielectric layer 21 and the second dielectric layer 22 are identical, it is possible to simplify the manufacturing process. The first dielectric layer 21 may be a layer containing four components: zinc oxide, indium oxide, titanium oxide, and tin oxide as primary components, similarly as the second dielectric layer 22. In this case, the specific proportion of each of the metallic oxide based on the total of the four components in the first dielectric layer 21 may be the same as in the second dielectric layer 22.

The second dielectric layer 22 is a layer containing the four components as primary components, whereas the first dielectric layer 21 may be a layer containing three components: zinc oxide, indium oxide, and titanium oxide as primary components. This enables the transparency to be kept high and the production cost to be reduced. In this case, the electrical conductivity of the first dielectric layer 21 becomes lower than that of the second dielectric layer 22, but there is no particular problem because the electric conductivity can be ensured by the second dielectric layer 22.

The thicknesses of the first dielectric layer 21 and the second dielectric layer 22 are, for example, 3 to 70 nm, and preferably 5 to 50nm from the viewpoint of achieving both high transparency and high electric conductivity at a high level. The thicknesses of the first dielectric layer 21 and the second dielectric layer 22 may be the same or different from each other. For example, by individually adjusting the thicknesses of the first dielectric layer 21 and the second dielectric layer 22, it is possible to prevent changes in the transmissive color tone or to effectively utilize an optical interference effect for converting the reflection light to be generated in the metal layer into the transmitted light.

The first dielectric layer 21 and the second dielectric layer 22 can be formed by a vacuum film-forming method such as a vacuum vapor deposition method, a sputtering method, an ion-plating method, or a CVD method. Among these methods, the sputtering method is preferable because the film formation chamber can be miniaturized and the film formation rate is high. Examples of the sputtering method include DC magnetron sputtering. As the target, an oxide target, or a metal or semi-metal target can be used.

The metal layer 24 may contain one or both of silver and silver alloy as a primary component. The total content of silver and silver alloy in the metal layer 24 may be, for example, 90% by mass or more, or 95% by mass or more in terms of silver element. The metal layer 24 may contain a metal (alloy) other than silver and silver alloy. For example, containing at least one element selected from the group consisting of Cu, Ge, Ga, Nd, Pt, Pd, Bi, Sn, and Sb as a constituent element of the silver alloy or a single metal as the metal or the alloy can improve the environmental resistance of the metal layer 24. Examples of the silver alloys include Ag—Pd, Ag—Cu, Ag—Pd—Cu, Ag—Nd—Cu, Ag—In—Sn, and Ag—Sn—Sb.

The metal layer 24 may be 3 to 20 nm or 5 to 15 nm from the viewpoint of sufficiently reducing the absorption rate of visible light. When the metal layer 24 is too thick or too thin, the absorption rate of visible light tends to increase.

The metal layer 24 can be formed with, for example, DC magnetron sputtering. The film formation method for the metal layer 24 is not particularly limited, and another vacuum film forming method using plasma, ion beam, or the like, a coating method using a liquid of constituent components dispersed in an appropriate binder, or the like can be appropriately selected.

The ITO layer is a layer having higher electrical conductivity than the second dielectric layer 22. By providing the ITO layer 26, it is possible to improve the freedom of selecting the material of the second dielectric layer 22. The ITO layer 26 may contain inevitable impurities in addition to ITO. By providing the ITO layer 26, the contact resistance can be sufficiently reduced when the electrode is connected to the second dielectric layer 22 side. When the ITO layer 26 and the second dielectric layer 22 are in direct contact with each other, high transparency can be sufficiently maintained while the film heater 100 is sufficiently thin.

The thickness of the ITO layer 26 is, for example, 5 to 40 nm, and preferably 10 to 30 nm, from the viewpoint of reducing both the reflectivity and transmissivity of visible light in a balanced manner.

The ITO layer 26 can be formed by using DC-magnetron sputtering, for example. The film forming method of the ITO layer 26 is not particularly limited, and another vacuum film forming method using plasma, ion beam, or the like, a coating method using a liquid in which constituent components are dispersed in an appropriate binder, or the like can be appropriately selected.

A part of the ITO layer 26 in the film heater 100, a part of the second dielectric layer 22, and a part of the metal layer 24 may have been removed by etching or the like. In this case, a conductive pattern is formed by the metal layer 24, the second dielectric layer 22, and the ITO layer 26. A part of the first dielectric layer 21 may also be removed by etching or the like.

The film heater 100 may have one or more optional layers in addition to those described above. The film heater 100 is suitably used for vehicles, outdoor display devices, and buildings. For example, the film heater 100 may be attached to the surface of a liquid crystal panel to improve the visibility and driving properties of the liquid crystal. However, the use of the film heater 100 is not limited to that described above. The film heater may be adhered on one side of the glass to form a film heater-equipped glass.

The transmissivity of visible light from a surface 100b on the side opposite to the surface 100a of the film heater 100 toward the surface 100a may be, for example, 70% or more, 75% or more, or 80% or more. Such a film heater is suitably used for vehicular glass (for example, for windshield and rear glass) which is required to have high transparency and excellent defrosting performance and defogging performance.

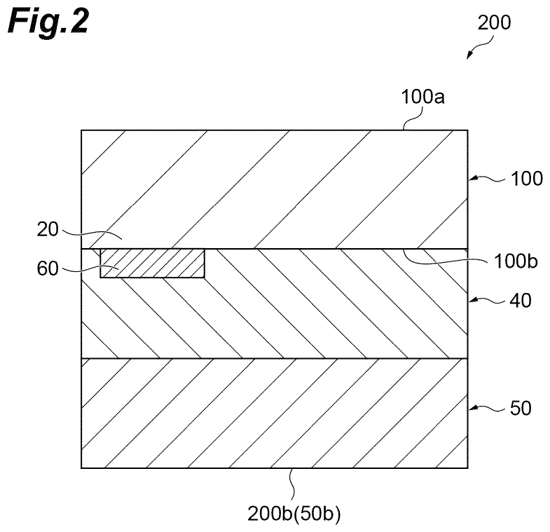

FIG. 2 is a schematic cross-sectional view illustrating an example of a heater-equipped glass. A heater-equipped glass 200 of FIG. 2 includes: the film heater 100 of FIG. 1; a glass plate 50 forming a surface 200b opposite to the surface 100a of the film heater 100; an adhesive layer 40 between the glass plate 50 and the film heater 100 (the transparent heating element 20); and an electrode 60 in contact with the transparent heating element 20 of the film heater 100. The electrode 60 is formed so as to cover a part of the transparent heating element 20 contained in the film heater 100. The electrode 60 may be formed, for example, by applying silver paste to the surface 100b on the transparent heating element 20 side of the film heater 100. After the electrode 60 is provided so as to cover a part of the surface 100b of the film heater 100 (the transparent heating element 20) as described above, the adhesive is applied so as to cover the other part of the surface 100b of the film heater 100 (the transparent heating element 20) and the electrode 60, and the glass plate 50 is arranged so as to face the transparent heating element 20 and the electrode 60 of the film heater 100. The heater-equipped glass 200 is then obtained by compressing the glass plate 50, the film heater 100 (the transparent heating element 20) and the electrode 60 in opposite directions. The adhesive forming the adhesive layer 40 may be an optical glue, for example.

On the surface 100b on the transparent heating element 20 side of the film heater 100, the electrode 60 may be provided in pairs. A power source (not shown) is connected to the pair of the electrodes 60, and the film heater 100 is heated by supplying electricity. This makes it possible to remove not only water droplets sticking to the surface 100a of the film heater 100 but also ice, frost, and the like sticking to the surface 50b (exposed surface) of the glass plate 50. The surface resistivity of the film heater 100 may be, for example, 5 to 30 Ω/sq. and may be 10 to 20 Ω/sq.

In the example of FIG. 2, the heater-equipped glass 200 includes the film heater 100, but is not limited thereto. For example, a variation thereof may be provided instead of the film heater 100.

Although the embodiments of the present disclosure have been described above, the present disclosure is not limited to the above-described embodiments. For example, a modified example of the film heater 100 may include an indium zinc oxide (IZO) layer instead of the ITO layer 26.

The present disclosure includes the following [1] to [5].

[1] A film heater including:
a transparent substrate; and
a transparent heating element,
wherein a surface of the transparent substrate opposite to the transparent heating element has a water contact angle of 55° or less or 90° or more.

[2] The film heater according to [1], further including, on a side of the transparent substrate opposite to the transparent heating element, a first hard coat layer containing a first resin component, the first hard coat layer having the surface.

[3] The film heater according to [1] or [2], wherein the transparent heating element is layered, and includes a first dielectric layer, a metal layer containing one or both of silver and silver alloy, and a second dielectric layer in the order presented along a stacking direction of the transparent substrate and the transparent heating element.

[4] The film heater according to any one of [1] to [3], further including a second hard coat layer containing a second resin component and a filler between the transparent substrate and the transparent heating element.

[5] A heater-equipped glass including: the film heater according to any one of [1] to [4]; a glass plate opposite to the surface; and an electrode in contact with the transparent heating element of the film heater, the electrode being disposed between the film heater and the glass plate.

### EXAMPLE

The content of the present disclosure will be described in more detail with reference to examples and comparative examples, but the present disclosure is not limited to the following Examples.

### Fabrication of Film Heater

### Example 1

A polyethylene terephthalate (PET) film having a thickness of 125 μm was prepared as a base material. A first hard coat layer was formed on one surface of the PET film. Specifically, a resin composition containing an acrylic monomer (curable compound), a hydrophilic component, and a photopolymerization initiator was blended with a solvent to prepare a first coating material. As the acrylic monomer, Z-737-9CL (product name) manufactured by Aica Kogyo Company, Limited was used. As the hydrophilic component, AICAAITRON Z-948-2L (product name) manufactured by Aica Kogyo Company, Limited was used. As the photopolymerization initiator, Irgacure 127 (product name) manufactured by Ciba Specialty Chemicals was used. Methyl ethyl ketone was used as the solvent. Based on the mass of the resin composition, the content of the photopolymerization initiator was 5% by mass, and the content of the hydrophilic component was 90% by mass. The content of the solvent based on the mass of the first coating material was 80% by mass.

The first coating material was applied to one surface of the PET film, dried, and cured by irradiation with ultraviolet rays to form a first hard coat layer.

A second hard coat layer was formed on the other surface of the PET film. Specifically, a resin composition containing a filler-containing acrylic monomer (curable compound) and a photopolymerization initiator was blended with a solvent to prepare a second coating material. As the filler-containing acrylic monomer, Z-737-5AL (product name) manufactured by Aica Kogyo Company, Limited was used. As the photopolymerization initiator, Irgacure 127 (product name) manufactured by Ciba Specialty Chemicals was used. Methyl ethyl ketone was used as the solvent. The content of the photopolymerization initiator was 5% by mass based on the mass of the resin composition. The content of the solvent based on the mass of the second coating material was 80% by mass.

The second coating material was applied onto the other surface of the PET film, dried, and cured by irradiation with ultraviolet light to form the second hard coat layer.

A high refractive index layer was formed on the second hard coat layer by DC magnetron sputtering. This high refractive index layer was formed by using a boron-doped Si target in a mixed atmosphere containing 80% by volume of argon gas and 20% by volume of nitrogen gas. The high refractive index layer thus formed was composed of SiN. The refractive index of the high refractive index layer was 1.9. A first dielectric layer, a metal layer containing silver alloy, a second dielectric layer, and an ITO layer were formed in this order on the high refractive index layer.

The first dielectric layer was formed by using a ZnO—In₂O₃—TiO₂ target, and the second dielectric layer was formed by using a ZnO—In₂O₃—TiO₂—SnO₂ target. The composition of each target (molar ratio) was as shown in Table 1. The first dielectric layer and the second dielectric layer each had the same composition as the target.

The metal layer was formed using an Ag—Pd—Cu target. The composition of the target was Ag:Pd:Cu=99.0:0.5:0.5 (% by mass). The metal layer had the same composition as the target. The ITO layer was formed using an ITO target (In₂O₃—SnO₂ target) in a mixed atmosphere of argon gas and oxygen gas (Ar:O₂=98% by volume: 2% by volume). The composition of the ITO target was In₂O₃:SnO₂=92:8 (% by mass). The ITO layer had approximately the same composition as the ITO target.

In this manner, a stacked body (film heater) including the first hard coat layer, the PET-made substrate, the second hard coat layer, the high refractive index layer, the first dielectric layer, the metal layer, the second dielectric layer, and the ITO layer in the order presented was obtained. The obtained stacked body was cut along the stacking direction by using a focused ion beam apparatus (FIB). The cut surface was observed with a transmission electron microscope to determine the thickness of each layer. As a result, the first hard coat layer was 1.5 μm thick, the second hard coat layer was 1.5 μm thick, the high refractive index layer was 20 nm thick, the first dielectric layer was 15 nm thick, the metal layer was 5.8 nm thick, the second dielectric layer was 15 nm thick, and the ITO layer was 20 nm thick.

TABLE 1

| | ZnO | In₂O₃ | TiO₂ | SnO₂ |
|---|---|---|---|---|
| First dielectric layer | 77 | 14 | 9 | 0 |
| Second dielectric layer | 35 | 29 | 14 | 22 |

### Fabrication and Assessment of Heater-Equipped Glass

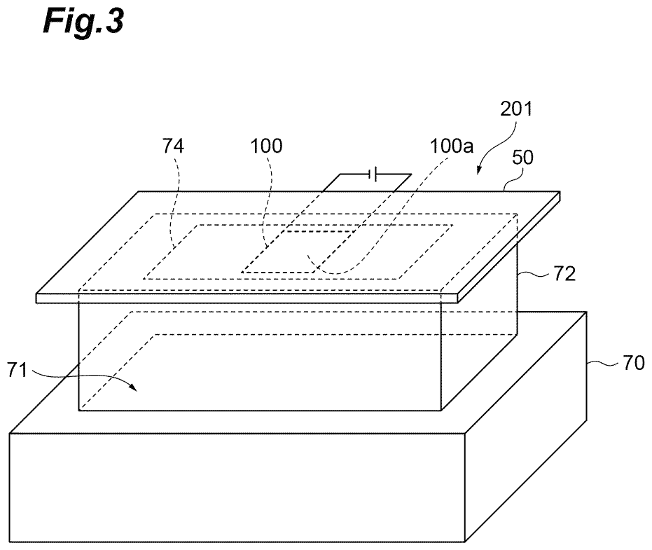

The film heater 100 fabricated as described above was used to fabricate a heater-equipped glass 201 shown in FIG. 3. In detail, a pair of electrodes were formed on the surface of the ITO layer of the film heater 100 using silver paste. Optical paste was applied so as to cover the surface of the ITO layer and the pair of electrodes, and the film heater 100 and the glass plate 50 were superimposed so that the surface of the ITO layer, the pair of electrodes, and the surface of the glass plate faced each other via the optical paste. Then, the film heater 100 and the glass plate 50 were compressed to obtain the heater-equipped glass 201.

Next, an evaluation apparatus illustrated in FIG. 3 was prepared. A containing portion 71 of a water bath 70 was filled with water, and the water temperature was adjusted to 40° C. An acrylic resin-made housing 72 was placed so as to cover the containing portion 71. The housing 72 had no bottom plate and an opening 74 formed on top. The heater-equipped glass 201 was placed so as to cover the opening 74 of the acrylic resin-made housing 72 in a thermostatic bath whose temperature was controlled to 5° C. At this time, the surface 100a of the film heater 100 (initial temperature: 5° C.) was exposed to the opening 74.

After a lapse of 0.5 minutes from the placement, contact angles of water droplets sticking to the surface 100a were measured using Drop Master Dmo-702 (product name) manufactured by Kyowa Interface Science Co., Ltd. The contact angles of 10 randomly selected water droplets were measured, and the average value (θ) thereof was obtained. The contact angles were measured when the temperature of the surface 100a dropped to 20° C. The results are shown in Table 2.

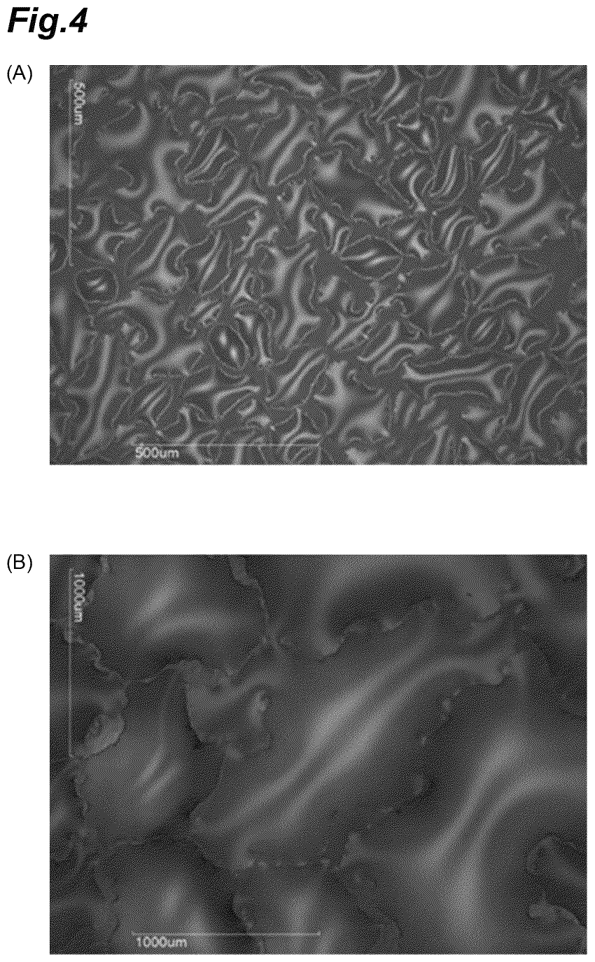

After the lapse of 0.5 minutes, the surface 100a and water droplets sticking to the surface 100a were photographed using an optical microscope and a camera attached thereto (FIG. 4(A)). From these photographs, the number N of water droplets per 1 mm² of the surface 100a and the volumes V of individual water droplets were calculated. The sticking amount of water droplets per 1 mm² of the surface 100a was calculated by a calculation formula of N×V. The calculation results were as shown in the column of “water sticking amount” in Table 2. The volume V of the water droplet can be estimated as the volume of a partially missing sphere. Accordingly, assuming that the shape of the water droplet is a part of a sphere, the volume V of the water droplet was obtained by the following Expressions (1), (2), and (3).

$$V = 1 / 6 \times π \times h \times ( 3 {r}^{2} + {h}^{2} ) \qquad ( 1 )$$

$$H = b \times tan ( θ / 2 ) \qquad ( 2 )$$

$$R = b / sin θ \qquad ( 3 )$$

In Expressions (1) to (3), r is the radius of the sphere, and h is the height of the water droplet from the surface 100a. θ in Expressions (2) and (3) is the water contact angle (°). b is the radius of the water droplet on the surface 100a. In a case where the shape of the water droplet on the surface 100a was not circular, the radius was defined as the radius of a circle having the same area. Each radius b at the surface 100a of randomly selected 10 water droplets was measured, and the mean value thereof was adopted to obtain the volumes V of the water droplets by the Expressions (2), (3) and (1).

After a lapse of 0.5 minutes (exposure time: 0.5 minutes), a current was applied to the film heater 100 and the time until water droplets of the surface 100a could be removed (removing time) was measured. The current value was constant at 0.8A. The results are shown in Table 2.

After it was confirmed that water droplets could be removed from the surface 100a, the heater-equipped glass 201 was removed from the evaluating device and cooled to 5° C. Thereafter, as illustrated in FIG. 3 again, the heater-equipped glass 201 was placed so as to cover the opening 74 of the housing 72. After a lapse of 1 minute from the placement (exposure time: 1.0 minutes), the water sticking amount and the removal time were measured in the same manner as in the case of the exposure time of 0.5 minutes. The results are shown in Table 2.

In each of the cases where the exposure time was set to 1.5 minutes, 3 minutes, 5 minutes, 10 minutes, and 15 minutes, the sticking amount of water droplets and the removal time were measured in the same manner as the above-described procedure. The results are shown in Table 2. FIG. 4(B) is an optical micrograph showing water droplets sticking to the surface 100a when the exposure time is 3 minutes. The temperature of the surface 100a of the film heater 100 at the time of measurement of the removing time remained at 41 to 47° C. in all cases of the exposure time. The temperature was measured using a thermocouple.

### Example 2

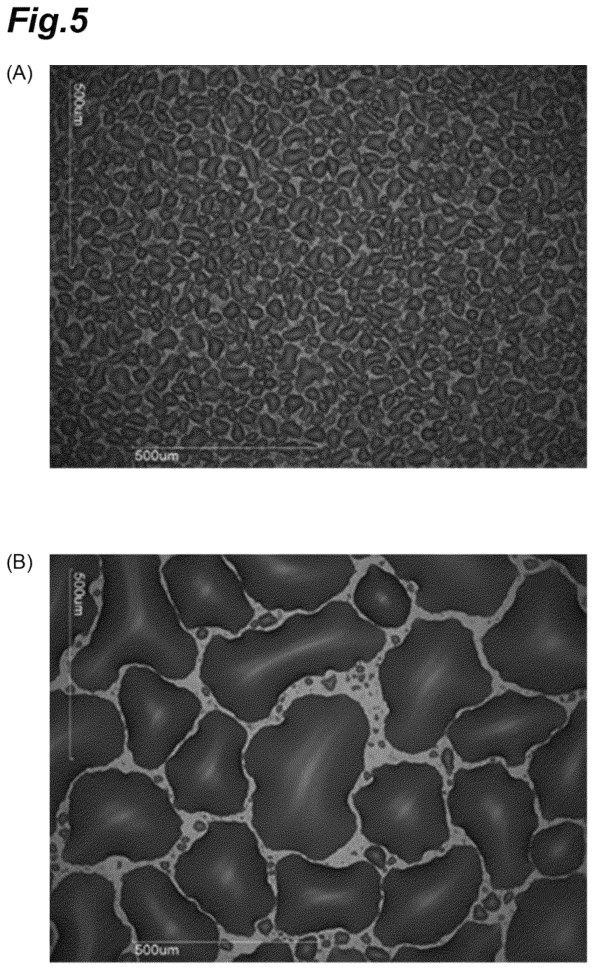

A film heater and a heater-equipped glass were fabricated in the same manner as in Example 1 except that the content of the hydrophilic component was 37% by mass by increasing the mixing ratio of the acrylic monomer to the hydrophilic component and that a first hard coat layer was formed by using the first coating material. Each measurement was performed in the same manner as in Example 1. The results are shown in Table 2. FIG. 5(A) is an optical microscope photograph showing water droplets sticking to the surface 100a when the exposure time is 0.5 minutes. FIG. 5(B) is an optical micrograph showing water droplets sticking to the surface 100a when the exposure time is 3 minutes. The temperature of the surface 100a of the film heater 100 at the time of measurement of the removing time remained at 42 to 45° C. in all cases of the exposure time.

### Example 3

Pholucid 540C (product name) manufactured by CHUGOKU MARINE PAINTS, LTD. was prepared as a hydrophobic component. This hydrophobic component was used in place of the hydrophilic component in the first coating composition of Example 1 to prepare a first coating composition as follows. The content of the photopolymerization initiator was 5% by mass and the content of the hydrophobic component was 80% by mass based on the mass of the resin composition. The content of the solvent was 80% by mass based on the mass of the second coating material. The acrylic monomer, photopolymerization initiator, and solvent used were the same as those used in Example 1. A stacked body (film heater) and a heater-equipped glass were fabricated by the same procedure as in Example 1 except that the first coating material prepared in this manner was used and that a first hard coat layer was formed using the first coating material. Each measurement was performed in the same manner as in Example 1. The results are shown in Table 2.

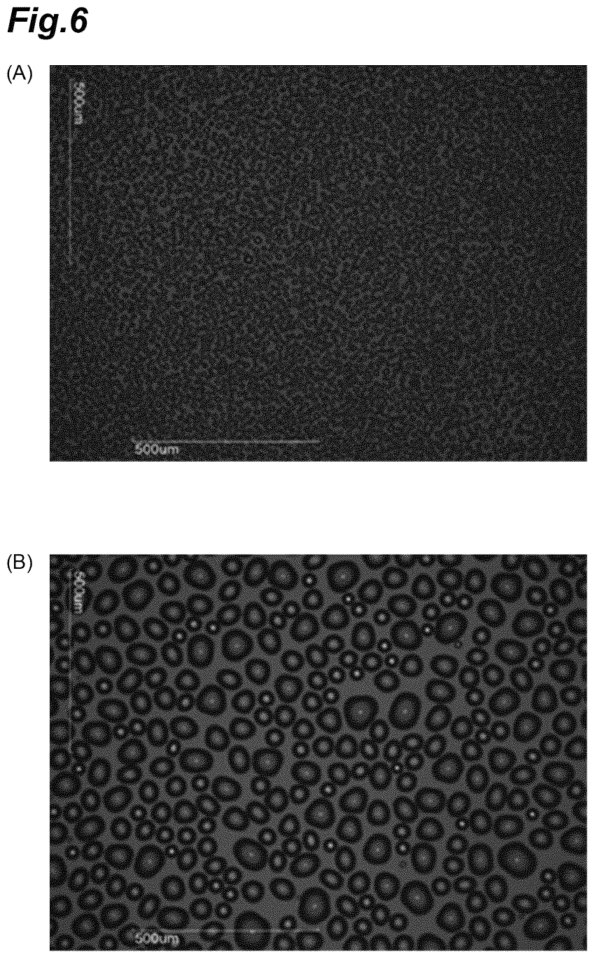

FIG. 6(A) is an optical microscope photograph showing water droplets sticking to the surface 100a when the exposure time is 0.5 minutes. FIG. 6(B) is an optical micrograph showing water droplets sticking to the surface 100a when the exposure time is 3 minutes. The temperature of the surface 100a of the film heater 100 at the time of measurement of the removing time remained at 41 to 47° C. in all cases of the exposure time.

### Comparative Example 1

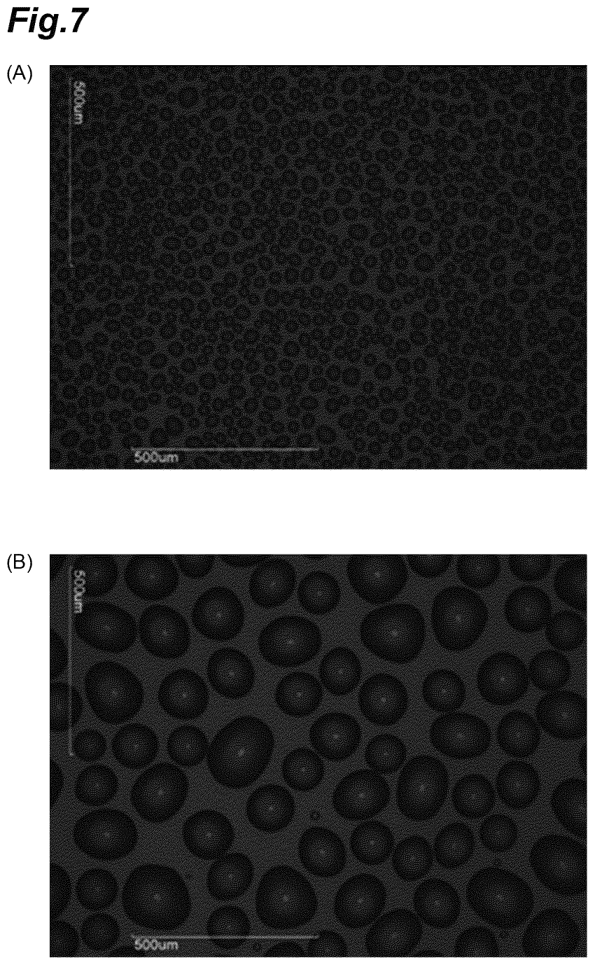

A film heater and a heater-equipped glass were fabricated in the same manner as in Example 1, except that no hydrophilic components were added to the first coating material. Each measurement was performed in the same manner as in Example 1. The results are shown in Table 2. FIG. 7(A) is an optical microscope photograph showing water droplets sticking to the surface of the film heater when the exposure time is 0.5 minutes. FIG. 7(B) is an optical microscope photograph showing water droplets sticking to the surface of the film heater when the exposure time is 3 minutes.

TABLE 2

| | | | | | Comparative | | | |
|---|---|---|---|---|---|---|---|---|
| | Example 1 | | Example 2 | | Example 1 | | Example 3 | |
| | water contact angle | | | | | | | |
| | 18° | | 45° | | 70° | | 100° | |
| | water | | water | | water | | water | |
| exposure | sticking | removal | sticking | removal | sticking | removal | sticking | removal |
| time | amount | time | amount | time | amount | time | amount | time |
| [minute] | [μL/mm²] | [second] | [μL/mm²] | [second] | [μL/mm²] | [second] | [μL/mm²] | [second] |
| 0.5 | 8.3E−02 | 219 | 4.5E−03 | 196 | 5.9E−03 | 242 | 4.08−03 | 189 |
| 1.0 | 1.5E−01 | 207 | 8.1E−03 | 201 | 8.6E−03 | 269 | 5.0E−03 | 195 |
| 1.5 | 1.6E−01 | 208 | 1.5E−02 | 214 | 9.9E−03 | 290 | 7.0E−03 | 211 |
| 3.0 | 3.3E−01 | 245 | 3.4E−02 | 244 | 1.6E−02 | 366 | 1.4E−02 | 248 |
| 5.0 | — | 284 | 6.8E−02 | 269 | 2.3E−02 | 470 | 2.0E−02 | 288 |
| 10 | — | 368 | 1.5E−01 | 365 | 4.6E−02 | 699 | 4.2E−02 | 424 |
| 15 | — | 473 | 2.3E−01 | 496 | 7.3E−02 | 950 | 4.8E−02 | 557 |

In Table 2, expressions “E-01”, “E-02”, and “E-03” represent “×10⁻¹”, “×10⁻²”, and “×10⁻³”, respectively. As shown in Table 2, in Examples 1, 2, and 3, the time for removing water droplets was shorter than that in Comparative Example 1. It is noted that in Example 1, when the exposure time was 5 minutes or more, the liquid droplet became a film shape, and the water sticking amount could not be calculated. However, the removal time was shorter than in Comparative Example 1.

The water sticking amount of Example 3 was smaller than that of Comparative Example 1. Thus, it is considered that the removal time can be shortened. The water sticking amount of Example 1 was much larger than that of Comparative Example 1. However, the removal time of Example 1 was the shortest. This is considered to be because the contact areas between the water droplets and the surface (exposed surface) of the film heater were large. Example 2 also had the same tendency as Example 1. When the exposure time was 0.5 minutes and 1.0 minutes, the water sticking amount of Example 2 was smaller than that of Comparative Example 1. This is considered to be a factor of measurement error.

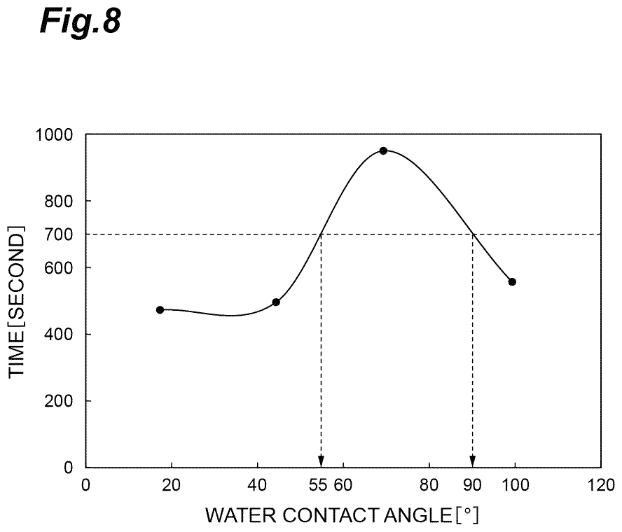

FIG. 8 shows the relationship between the water contact angle and the removal time required to remove water droplets when the exposure time is 15 minutes. It was confirmed that the water contact angle needs to be 55° or less or 90° or more in order to set the removal time to 700 seconds or less. Further, it was confirmed that the removal time can be further shortened (about 600 seconds or less) by setting the water contact angle to 50° or less or 95° or more.

### Industrial Applicability

According to the present disclosure, it is possible to provide a film heater capable of rapidly reducing water droplets. It is also possible to provide a heater-equipped glass comprising such a film heater.

### REFERENCE SIGNS LIST

10: transparent substrate, 11: first hard coat layer, 12: second hard coat layer, 15: high refractive index layer, 20: transparent heating element, 21: first dielectric layer, 22: second dielectric layer, 24: metal layer, 26: ITO layer, 40: adhesive layer, 50: glass plate, 50b: surface, 60: electrode, 70: water bath, 71: containing portion, 72: housing, 74: opening, 100: film heater, 100a, 100b: surface, 200, 201: heater-equipped glass.

1. A film heater comprising:
a transparent substrate; and
a transparent heating element,
wherein a surface of the transparent substrate opposite to the transparent heating element has a water contact angle of 55° or less or 90° or more.

2. The film heater according to claim 1, further comprising, on a side of the transparent substrate opposite to the transparent heating element, a first hard coat layer containing a first resin component, the first hard coat layer having the surface.

3. The film heater according to claim 1, wherein the transparent heating element is layered, and comprises a first dielectric layer, a metal layer containing one or both of silver and silver alloy, and a second dielectric layer in the order presented along a stacking direction of the transparent substrate and the transparent heating element.

4. The film heater according to claim 1, further comprising a second hard coat layer containing a second resin component and a filler between the transparent substrate and the transparent heating element.

5. A heater-equipped glass comprising:
the film heater according to claim 1;
a glass plate opposite to the surface; and
an electrode in contact with the transparent heating element of the film heater, the electrode being disposed between the film heater and the glass plate.

6. The film heater according to claim 2, wherein the transparent heating element is layered, and comprises a first dielectric layer, a metal layer containing one or both of silver and silver alloy, and a second dielectric layer in the order presented along a stacking direction of the transparent substrate and the transparent heating element.
